(19) United States
(12) Patent Application Publication
(10) Pub. No.: US 2024/0250532 A1
(43) Pub. Date: Jul. 25, 2024

(54) ELECTRICAL APPARATUS WITH PRIMARY VOLTAGE POWER CORRECTION

(71) Applicant: Karle Patents Inc., Edmonton (CA)

(72) Inventor: Shawn Murray Karle, Edmonton (CA)

(21) Appl. No.: 18/092,815

(22) PCT Filed: Mar. 5, 2021
(86) PCT No.: PCT/CA2021/050302

§ 371 Date: Jan. 3, 2023

Related U.S. Application Data
(60) Provisional application No. 63/057,790, filed on Jul. 28, 2020.

(51) Int. Cl. H02J 3/12; H02B 1/04

(52) U.S. Cl. CPC H02J 3/12; H02B 1/04; H02J 2310/10

(57) ABSTRACT

An electrical distribution apparatus is disclosed, having a supply terminal structured to receive distribution electricity from a primary circuit; a power corrector configured to correct the distribution electricity to reduce a voltage drop in the distribution electricity from a line voltage; and a distribution terminal structured to supply all or part of the distribution electricity to a load, feeder or branch circuit. Related methods and apparatuses are also described.

### TECHNICAL FIELD

This document relates to electrical apparatus with primary voltage power correction.

### BACKGROUND

The following paragraphs are not an admission that anything discussed in them is prior art or part of the knowledge of persons skilled in the art.

Electrical equipment is now being manufactured to allow for higher temperature rated field conductors, then the equipment's temperature rating, as an example U.S. Pat. No. 10,615,578 B2 and Canadian Patent No. 2,986,409. In some cases voltage drop in primary circuits is addressed using larger gauge conductors.

### SUMMARY

This document relates to electrical equipment currently categorized at 30 volts+/− to 1000 Volts+/− or less. The current Canadian Electrical Code (CEC) categorizes such equipment at 30 volts+/− to 750 volts+/− or less, and the North American Code (NEC) currently categorizes it at 50 volts+/− to 1000 volts+/−, or less, for example. Electrical equipment and systems typically have an allowable variance, for example 10%, in the voltage supplied and or used at loads, and hence voltage ratings in this document may be considered to be+/− when discussing extremes of range.

An electrical apparatus comprising: a primary circuit connected to a) receive incoming electricity at a line voltage and b) to supply distribution electricity; a secondary circuit; and a power corrector connected to: receive distribution electricity from the primary circuit; correct the distribution electricity to reduce a voltage drop in the distribution electricity from the line voltage; and distribute all or part of the distribution electricity to the secondary circuit.

A method is also disclosed comprising operating an electrical apparatus to receive incoming electricity at the primary circuit, supply distribution electricity to the power corrector, reduce the voltage drop from line voltage at the power corrector, and supply all or part of the distribution electricity to the secondary circuit to operate a load.

An electrical distribution panel is also disclosed comprising: a supply terminal structured to receive distribution electricity from a primary circuit; a power corrector configured to correct the distribution electricity to reduce a voltage drop in the distribution electricity from a line voltage; and a distribution terminal structured to supply all or part of the distribution electricity to a load, feeder or branch circuit.

Electrical equipment with primary circuit, being line voltage in, or alternately known as incoming power; voltage and or power correction, prior too secondary or load side, line voltage, distribution and or load utilization.

Electrical equipment with primary circuit, being line voltage in, or alternately known as incoming power; voltage and or power correction, with optional transformation and or isolation, prior too secondary or load side, line voltage, distribution and or load utilization.

Electrical equipment accounting for branch circuit or feeder voltage drop tolerances in circuit conductors and the pertaining electrical equipment in use.

Electrical equipment accounting for branch circuit or feeder voltage drop in circuit conductors and the pertaining electrical equipment with the option of providing transformation and isolation.

Electrical equipment with capacity to supply a neutral or an isolated grounding conductor, at a secondary point within a branch circuit or feeder and or at the load utilization point while maintaining circuit line voltage.

Electrical equipment with capacity to supply neutral or an isolated grounding conductor for unbalanced loads within a given circuit.

Electrical equipment with additional capacity to account voltage drop adherent to high temperature field conductor installations.

Electrical equipment with additional capacity to account for additional voltage drop and the high temperature, high current issues due to using high temperature rated field conductors when they are sized for such, in a 1000V+/− or less electrical system.

In various embodiments, there may be included any one or more of the following features: The secondary circuit is connected to a load, feeder, or branch circuit. The secondary circuit comprises one or more of a distribution panel, fused disconnect switch, unfused disconnect switch, motor disconnect switch, splitter, transformer, switchgear, motor starter, motor controller, motor, generator, light fixture, voltage modifier, current modifier, power monitor, or power meter. The power corrector comprises a transformer. The transformer is output voltage adjustable. The secondary circuit is isolated from the primary circuit. The secondary circuit comprises a neutral grounding conductor isolated from the primary circuit. The primary circuit comprises a neutral grounding conductor. The power corrector is connected to eliminate the voltage drop. The primary circuit originates from a first distribution panel in a building. The power corrector is mounted on a second distribution panel in the building. The second distribution panel comprises a circuit breaker that forms part of the secondary circuit. The primary circuit and the secondary circuit are: dual coil single phase, one pole circuits; dual coil single phase, two pole circuit terminals; or dual coil three phase, three pole circuits. The power corrector comprises one or more of: an electrical power corrector; an electrical and mechanical power corrector; or an electronic and electrical power corrector. The power corrector comprises an electrical and mechanical power corrector, which has dual wound coils with a rotatable core, with electronic monitoring that can automatically operate the coil, via mechanically connected motors and gears attached to the rotatable core. The power corrector comprises an electronic and electrical power corrector, which comprises a variable frequency drive or automated sine wave device (an example of an electronic wave generating device). The electrical apparatus is rated at 1000 volts or less. The electrical apparatus is rated at more than 1000 volts.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a schematic view of an electrical apparatus with a primary distribution panel (single phase/single pole), a power corrector panel, and a secondary circuit connected with a load.

FIG. 2 is a schematic view of an electrical apparatus with a primary distribution panel (three phase/three pole), two power corrector panels, and a secondary circuit connected with a load.

FIG. 3 is a schematic view of an existing electrical apparatus with a primary distribution panel (three phase/three pole), a load, and a neutral isolated grounding conductor connected all the way back to the primary distribution panel.

### DETAILED DESCRIPTION

Immaterial modifications may be made to the embodiments described here without departing from what is covered by the claims.

This document relates to electrical equipment with primary circuit, being line voltage in, or alternately known as incoming power; correction, with optional transformation and or isolation, prior too secondary or load side, line voltage, distribution or load utilization, in electrical equipment typically rated at 1000V or less, thus accounting for branch circuit or feeder voltage drop in circuit conductors and the pertaining electrical equipment with the option of providing transformation and isolation.

Electrical equipment is now being manufactured to allow for higher temperature rated field conductors, then the equipment's temperature rating, as an example U.S. Pat. No. 10,615,578 B2. This is new technology, which can reduce the size in diameter of a field conductor(s) by using a higher temperature rated conductor insulation along with a temperature transition point within the pertaining electrical equipment, thus a smaller diameter conductor, however, reducing the diameter of a conductor increases resistance to current flow, this causes heating and voltage drop within the circuit conductor. Referring to FIG. 3, typical existing 1000V or less power distribution circuits include a neutral conductor along with one, two or three power conductors, which can be used as an isolated ground conductor for unbalanced loads, carried throughout the circuit from supply to load, see for example revised Canadian Electrical Code (CEC) rule 4-002. Typical power distribution contains multiple distribution points. Some examples of distribution points include a distribution panel with breakers or alternately a splitter with fused disconnect switches, at the incoming line voltage rating. The power is then distributed to loads at the line voltage supply rating via the distribution point. Alternatively, power is distributed at the line voltage supply rating to a transformer typically for an increase or decrease in voltage to supply loads that are not rated at the line voltage supply rating, such as 1000V supply voltage stepped down to 208V, for 208V rated loads, as an example.

Existing distribution points typically have no conductor, power or circuit isolation from the primary power supply point's electrical equipment at the rated voltage, to the secondary power distribution point electrical equipment at the rated voltage, or alternatively from the distribution point's rated voltage to the pertaining connected loads such as motors, when the loads are rated at the incoming supply voltage. The Canadian CEC and American National Electrical Code (NEC) both have limits to the allowable voltage drop, as per CEC rule 8-102 1) (b), i.e. there is a 5% tolerance from supply side of a consumer service, to the point of utilization. CEC rule 8-102 1) (a) applies to branch circuit or feeder conductors, where the tolerance is typically 3% maximum drop within the circuit, and CEC rule 8-102 4) Allows for more then 3% if the equipment is rated to handle the tolerance of voltage drop over the in this case allowable 3%, as an example.

An electrical apparatus is disclosed comprising; an incoming power corrector and or modifier, which could be but not limited to; electrical, mechanical, electronic and or in any combination of, meaning in some cases electrical only (wound coils with taps), or electrical and mechanical (dual wound coils with a rotatable core, which has electronic monitoring, which could automatically operate the coil, via mechanically connected motors and gears attached to the rotating coil), and or electronic and electrical (such as variable frequency drives which generate a new sign wave) and or other combination(s). In some case this could be a power transformer, which has the ability to correct the line voltage, typically up to or above the incoming line voltage rating and or required ratings such as 1000V, this correction may be necessary to stay within the range of electrical equipment, loads, circuit conductors and or but not limited to code tolerances, as pertaining to voltage drop and the increased current flow, which causes additional heating in circuit conductors and equipment at all voltages, but increases the lower the applied voltage based on the overall Volt Amp rating of circuits including conductors and equipment.

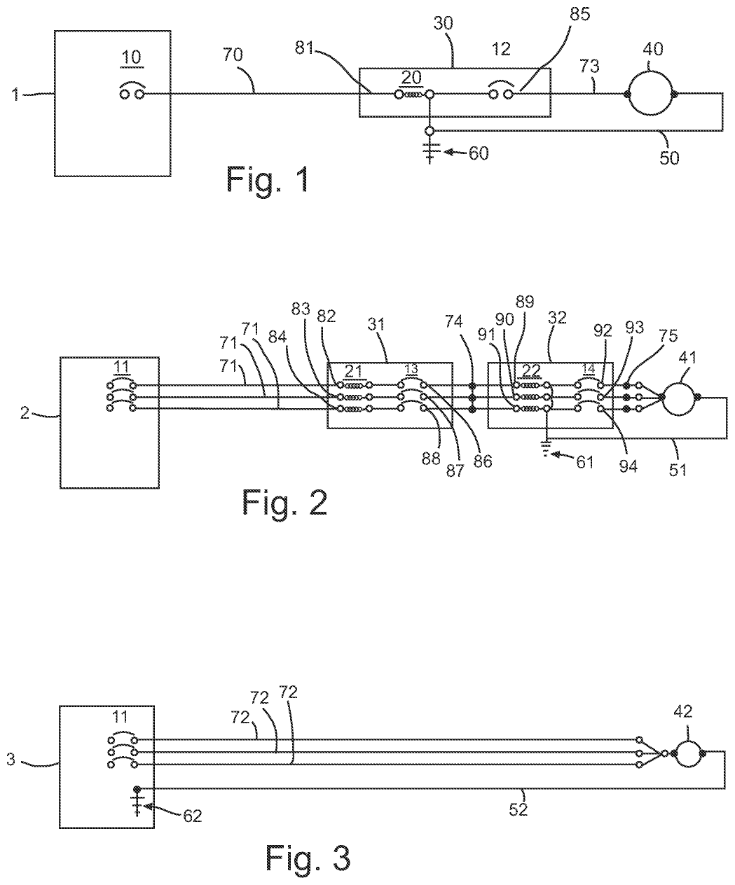

This technology when including, but not limited to, a transformer used as a power corrector, optionally an isolator and or modifier, may allow for the reduction or elimination of a neutral conductor between primary distribution points and secondary distribution points or load utilization points. Referring to FIG. 1 or 2, such may accomplished by adding a grounding conductor 50 or 51 closer in distance to the power supply correction or modification point being a power transformer in some cases. Thus, the neutral conductor 50 or 51 may be added to the pertaining circuit conductors and/or but not limited to electrical equipment if required, at a local distribution point, typically closer to the pertaining load utilization, then the primary distribution point for the pertaining circuit, or at the load utilization point itself. Examples of load utilization points may be, but are not limited to a motor. Removal of the neutral conductor may reduce the amount of conductor material, examples of material are copper and/or but not limited to aluminum, required for the circuit supplying loads and equipment for; by example, up to 50% in single phase, one pole circuits, up to 33% in single phase two pole circuits, and/or but not limited, up to 25% in three phase, three pole circuits, as one of the pertaining conductors, being the neutral or otherwise known as the isolated ground conductor 52 (FIG. 3), for example, may be removed completely and or optionally removed throughout a large portion of various branch circuits, feeders and or but not limited to electrical equipment in use.

Referring to FIGS. 1 and 2, the embodiments of this disclosure may be unique in that, existing 1000V or less, electrical equipment, conductors and or but not limited to circuitry, has no allowance to modify line voltage between the primary point of distribution within a system, at the applicable voltage, and the pertaining utilization point such as a load, at the same applicable voltage, applicable voltage variation consist of but not limited to, 120V/240V/208V/277V/347V/480V/600V, single or three phase, are commonly used in north America, however the embodiments of this disclosure include any variety of denominations 1000V or less, and in some cases higher, which are generic and allow for a plurality variations of and/or but not limited to a variety of voltage drop or line loss circuit correction points, to maintain circuits voltages, reduce heating, overcurrent and a variety of issues that pertain to voltage drop, and allow for higher temperature conductor(s) to be installed over a much longer distance, without having to increase the overall diameter of the pertaining conductor, or by not having to increase the diameter as much as existing requirements, to accommodate voltage drop tolerances, with electrical equipment, circuits and/or but not limited to conductors rated at 1000V or less, and in some case, higher voltages. This may be accomplished by correcting the applicable voltage on the primary side of the equipment, to stay within the 3% voltage drop CEC branch circuit rule for example, or by manufacturing the electrical equipment with a power corrector or modifier, which can account for a larger voltage drop then allowed by CEC code rule pertaining to branch circuits and feeders, with a tolerance over 3% for some cases, which a larger volt drop, over the 3% tolerance is required to be corrected, and designed specifically to accommodate such. Primary and secondary circuit isolation may also be a useful feature, being it is within the power supply to equipment, and pertains to some varieties of power correction and/or modification, such as when using dual core transformers, power surges, short circuits and/or but not limited to spikes, are stopped from coming in from the line side of the electrical equipment and or stopped from being sent back in reverse to the line side of equipment, due to the isolation between the magnetically field connected circuit, as there is no physical connection between circuit conductors on the primary incoming power supply of equipment, as an example when using a transformer as a line voltage corrector for 1000V or less electrical equipment.

Old technology in some cases, uses transformers, with multi tap or adjustable ranges for secondary power to loads, and these loads or electrical equipment have lower or higher voltages then the supplied line voltage, for example 1000V, however the primary line voltage as example 1000V, circuit conductors on both primary and secondary side of line voltage rated equipment, as well as the electrical equipment in use, has no correction. Even though there may still be the expense of having a transformer installed, there is none of the benefits of line voltage drop correction, line voltage isolation, reduction of up to fifty percent of the line voltage conductors, via the neutral conductor(s), feeders and/or material used for conductors, as the transformers are typically sized for the higher or lower voltage loads and not the primary voltage distribution and loads or utilization points, as well they are located on the secondary side of the line voltage equipment. There is no specific design or allowance for high temperature insulated conductors as pertains to the increased voltage drop here within.

Electrical equipment includes, but is not limited to, distribution panels, fused disconnect switches, unfused disconnect switches, motor disconnect switches, splitters, transformers, switchgear, motor starters, motor controllers, motors, generators, light fixtures, voltage modifiers, current modifiers, power monitors, power meters and the likes, 1000V or less, although higher voltages may be used. The embodiments of this disclosure include the embodiments her within, and any other variety of embodiments that could be obvious to a person in the skilled art, or applicable to this technology, present and future, are to be included here within and taken as part of the embodiments of this disclosure and the pertaining claims.

Referring to FIG. 1, electrical equipment (electrical apparatus 1) with a single pole breaker, supplying an unbalanced load, which has the neutral conductor deriving from the circuit corrector 30, modifier with the example showing a dual coil, single phase voltage correction. This drawing shows, the neutral goes to ground in the equipment and not back to the typical supply source of transformation existing.

Referring to FIG. 2, electrical equipment (electrical apparatus 2) with a three pole breaker, supplying and unbalanced load, which has the neutral conductor deriving from the circuit corrector 32, modifier with the example showing dual coil, three phase voltage correction. This drawing shows, the neutral goes to ground in the equipment 32 and not back to the typical supply source of transformation existing.

Referring to FIG. 3, electrical equipment (apparatus 3), with a three pole breaker, supplying and unbalanced load, which has the neutral deriving from the primary distribution point and typically transformation. This drawing show, the neutral conductor goes to ground at the primary point of service or primary distribution point typically after transformation. This is an example of existing circuits and electrical equipment, which are not part of this disclosure and it is only included for diagram cross reference purposes to differentiate old and existing compared to FIGS. 1 and 2.

List of reference numerals in FIGS. 1-3:
10. Primary line voltage supply breaker, single pole.
11. Primary line voltage supply breaker, three pole.
20. Dual coil single phase, one pole, circuit correction at primary line voltage rating, on the primary side of the distribution equipment 30 and supply breaker 12 pertaining to the load 40.
21. Dual coil three phase, three pole, circuit correction at primary line voltage rating, one the primary side of the distribution equipment 31, and supply breaker 13 pertaining to secondary distribution panel 32.
22. Dual coil three phase, three pole, circuit correction at primary line voltage rating, one the primary side of the distribution equipment 32, and supply breaker 14 pertaining to load 41.
30. Distribution equipment with power correction 20 and the addition of a neutral point 60 with power correction at the line voltage rating.
31. Distribution equipment with power correction 21 without the requirement for a neutral connection point.
32. Distribution equipment with power correction 22 and the addition of a neutral point 61 with power correction at the line voltage rating.
40. A single phase, single pole load.
41. A three phase, three pole load.
42. a three phase, three pole load.
50. Neutral conductor, single phase load connection to ground 60 in equipment 30.
51. Neutral conductor, three phase load connection to ground 61 in equipment 32.
52. Neutral conductor, three phase load connection to ground 62 in non equipment 3.
60. Ground connection for Neutral conductor 50 and circuit corrector coil 20.
61. Ground connection for Neutral conductor 51 and circuit corrector coil 22.
62. Ground connection for Neutral conductor 52 with no circuit corrector, back to source transformation 3.
70. Primary circuit conductors supplying circuit correction equipment 30.
71. Primary circuit conductors supplying circuit correction equipment 31 and 32.
72. Primary circuit conductors supplying load 42, without circuit correction and the neutral conductor 52 returning to supply or transformation point 3.

Referring to FIGS. 1 and 2, an electrical apparatuses 1 and 2 are illustrated each comprising a primary circuit (for example including conductors 70 and 71), a secondary circuit (for example including conductors 73 and 75), and a power corrector (for example transformers 20, 21, and 22). The primary circuit may be connected to a) receive incoming electricity (for example via distribution panels (apparatus) 1 or 2) at a line voltage and b) to supply distribution electricity. The primary circuit may originate from a distribution panel 1 or 2, such as a main distribution panel (MDP) or a central distribution panel (CDP), and in some cases, a branch circuit panel (BCP). An MDP may be located at the service entrance into a building or facility.

The power corrector may be connected to: receive distribution electricity from the primary circuit; correct the distribution electricity to reduce a voltage drop in the distribution electricity from the line voltage; and distribute all or part of the distribution electricity to the secondary circuit. The secondary circuit may be connected to a load 40 or 41, feeder 74, or branch circuit (for example electrical apparatus 31 or 32). The secondary circuit may comprise suitable parts, such as one or more of a distribution panel, fused disconnect switch, unfused disconnect switch, motor disconnect switch, splitter, transformer, switchgear, motor starter, motor controller, motor, generator, light fixture, voltage modifier, current modifier, power monitor, or power meter. The electrical apparatus may be rated at 1000 volts or less, for example 750 V of less, or 600 V or less. This document relates to electrical equipment rated typically rated between 30 volts+-to 1000 volts+-, or less, although in some cases the electrical system may be rated higher than 1000V.

Referring to FIGS. 1 and 2, the power corrector may comprise a transformer (20, 21, 22). The transformer may be output voltage adjustable, for example to tailor output voltage to minimize or eliminate voltage drop. In some cases voltage may be adjust to at or above line voltage (line voltage being incoming power voltage). The secondary circuit may be isolated from the primary circuit, for example if a transformer is used. The secondary circuit may comprise a neutral grounding conductor (50 and 51) isolated from the primary circuit. The primary circuit may comprise a neutral grounding conductor as well although there is no need to connect the conductors 50 and 51 all the way to the primary distribution point/primary circuit, thus saving costs in material and installation.

Other power correctors may be used. The power corrector may comprise one or more of: an electrical power corrector; an electrical and mechanical power corrector; or an electronic and electrical power corrector. In one case the power corrector comprises an electrical and mechanical power corrector, which has dual wound coils with a rotatable core, with electronic monitoring that can automatically operate the coil, via mechanically connected motors and gears attached to the rotatable core. In another case the power corrector comprises an electronic and electrical power corrector, which comprises a variable frequency drive or automated sine wave device. Other devices may be used.

Referring to FIGS. 1 and 2 the electrical apparatus may have other suitable parts and may operate in various contexts. The electrical apparatus may be located in a building. For example, The primary circuit may originate from a first distribution panel 1 or 2 in a building. The power corrector may be mounted on a second distribution panel 30, 31, or 32, in the building. The second distribution panel may comprise circuit disconnect ability such as view a circuit breaker 12, 13, or 14, that forms part of the secondary circuit. The primary circuit and the secondary circuit may be: dual coil single phase, one pole circuits (FIG. 1); dual coil single phase, two pole circuit terminals (not shown); or dual coil three phase, three pole circuits (FIG. 3).

In use, the electrical apparatus may be operated to carry out a suitable method of operation. Incoming electricity may be received at the primary circuit. Distribution electricity may supplied to the power corrector. The power corrector may reduce the voltage drop from line voltage at the power corrector. The power corrector may supply all or part of the distribution electricity to the secondary circuit to operate a load 40 or 41.

Referring to FIGS. 1 and 2, the power corrector may be part of an electrical distribution panel, such as panels 30, 31, or 32. Such a panel may have one or more supply terminals (such as terminal 81 shown in FIG. 1, and terminals 82, 83, and 84 for panel 31 and terminals 89, 90, and 91 for panel 32 shown in FIG. 2 corresponding in the examples to the number of phases) structured to receive distribution electricity from the primary circuit. The power corrector may be mounted to the panel 30, 31, or 32, and configured to correct the distribution electricity to reduce a voltage drop in the distribution electricity from a line voltage. The panel may have one or more distribution terminals (such as terminal 85 in FIG. 1, or terminals 86, 87, and 88 for panel 31 and terminals 92, 93, and 94 for panel 32 in FIG. 2) structured to supply all or part of the distribution electricity to a load 40 or 41, feeder or branch circuit. A neutral grounding conductor such as conductors 50, or 51 may be connected to the distribution terminals 85, 92, 93, or 94 and isolated from the supply terminals 81, 89, 90, and 91. A circuit breaker or breakers 12, 13, or 14 may be connected to the distribution terminals 85, 86, 87, 88, or 92, 93, 94 as the case may be.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. An electrical apparatus comprising:
a primary circuit connected to a) receive incoming electricity at a line voltage and b) to supply distribution electricity;
a secondary circuit; and
a power corrector connected to:
receive distribution electricity from the primary circuit;
correct the distribution electricity to reduce a voltage drop in the distribution electricity from the line voltage; and
distribute all or part of the distribution electricity to the secondary circuit.

2. The electrical apparatus of claim 1 in which the secondary circuit is connected to a load, feeder, or branch circuit.

3. The electrical apparatus of claim 1 in which the secondary circuit comprises one or more of a distribution panel, fused disconnect switch, unfused disconnect switch, motor disconnect switch, splitter, transformer, switchgear, motor starter, motor controller, motor, generator, light fixture, voltage modifier, current modifier, power monitor, or power meter.

4. The electrical apparatus of claim 1 in which the power corrector comprises a transformer.

5. The electrical apparatus of claim 4 in which the transformer is output voltage adjustable.

6. The electrical apparatus of claim 1 in which the secondary circuit is isolated from the primary circuit.

7. The electrical apparatus of claim 1 in which the secondary circuit comprises a neutral grounding conductor isolated from the primary circuit.

8. The electrical apparatus of claim 1 in which the primary circuit comprises a neutral grounding conductor.

9. The electrical apparatus of claim 1 in which the power corrector is connected to eliminate the voltage drop.

10. The electrical apparatus of claim 1 in which:
the primary circuit originates from a first distribution panel in a building; and
the power corrector is mounted on a second distribution panel in the building.

11. The electrical apparatus of claim 10 in which the second distribution panel comprises a circuit breaker that forms part of the secondary circuit.

12. The electrical apparatus of claim 1 in which the primary circuit and the secondary circuit are:
dual coil single phase, one pole circuits;
dual coil single phase, two pole circuit terminals; or
dual coil three phase, three pole circuits.

13. The electrical apparatus of claim 1 in which the power corrector comprises one or more of:
an electrical power corrector;
an electrical and mechanical power corrector; or
an electronic and electrical power corrector.

14. The electrical apparatus of claim 13 in which the power corrector comprises an electrical and mechanical power corrector, which has dual wound coils with a rotatable core, with electronic monitoring that can automatically operate the coil, via mechanically connected motors and gears attached to the rotatable core.

15. The electrical apparatus of claim 13 in which the power corrector comprises an electronic and electrical power corrector, which comprises a variable frequency drive or automated sine wave device.

16. The electrical apparatus of claim 1 in which the electrical apparatus is rated at 1000 volts or less.

17. The electrical apparatus of claim 16 in which the electrical apparatus is rated at 750 volts or less

18. The electrical apparatus of claim 1 in which the electrical apparatus is rated at more than 1000 volts.

19. A method comprising operating the electrical apparatus of claim 1 to receive incoming electricity at the primary circuit, supply distribution electricity to the power corrector, reduce the voltage drop from line voltage at the power corrector, and supply all or part of the distribution electricity to the secondary circuit to operate a load.

20. An electrical distribution panel comprising:
a supply terminal structured to receive distribution electricity from a primary circuit;
a power corrector configured to correct the distribution electricity to reduce a voltage drop in the distribution electricity from a line voltage; and
a distribution terminal structured to supply all or part of the distribution electricity to a load, feeder or branch circuit.

21. The electrical distribution panel of claim 20 in which the power corrector comprises a transformer.

22. The electrical distribution panel of claim 20 further comprising a neutral grounding conductor connected to the distribution terminal and isolated from the supply terminal.

23. The electrical distribution panel of claim 20 further comprising a circuit breaker connected to the distribution terminal.

24. The electrical distribution panel of claim 20 in which the supply terminal and the distribution terminal are:
dual coil single phase, one pole circuit terminals;
dual coil single phase, two pole circuit terminals; or
dual coil three phase, three pole circuit terminals.
